(19) United States
(12) Patent Application Publication
(10) Pub. No.: US 2008/0304767 A1
(43) Pub. Date: Dec. 11, 2008

(54) Image Processing Method, Image Processor, Drawing System, and Program

(75) Inventor: Takashi Toyofuku, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/886,035

(22) PCT Filed: Mar. 7, 2006
(86) PCT No.: PCT/JP2006/304833

§ 371 Date: Sep. 10, 2007

(30) Foreign Application Priority Data
Mar. 8, 2005 (JP) 2005-063983
Mar. 11, 2005 (JP) 2005-069322

(51) Int. Cl. G06K 9/36

(52) U.S. Cl. 382/284

(57) ABSTRACT

An image processing method and image processor obtain image data of piece images and layout information of each piece image, convert the image data into piece drawing data, and then, preferably after performing compression processing on the piece drawing data, arrange the piece drawing data in accordance with the layout information, to thereby create drawing data of an image composed of plural piece images arranged. A drawing system has the image processor described above, and a drawing device, which draws an image on a work based on drawing data that is created by the image processor. A program enables a computer to execute the image processing method described above.

### TECHNICAL FIELD

The present invention relates to an image processing method, an image processor, a drawing system, and a program. In particular, the present invention relates to an image processing method and an image processor that create drawing data of an image in which plural piece images are arranged, a drawing system that uses the image processor, and a program for executing the image processing method.

### BACKGROUND ART

Various image recording systems have conventionally been proposed which draw (create) a given pattern such as a printed wiring pattern on a recording medium that is to serve as a printed wiring board or the like (hereinafter referred to as substrate).

This type of image recording system has, for example, a CAD (Computer Aided Design) for designing basic printed wiring patterns, a CAM (Computer Aided Manufacturing) for editing the basic printed wiring patterns which are designed by the CAD into drawing pattern data (vector data or Gerber data), which describes a drawing pattern where the basic printed wiring patterns are arranged in a layout for a substrate that is to serve as a printed wiring board, an image processor such as an RIP (Raster Image Processor) for creating raster data (bitmap data) by rasterizing (converting) the drawing pattern data which is edited by the CAM, and an exposure device for drawing (exposing) an image on the substrate by using the raster data which is rasterized (the bitmap data which is converted) by the image processor.

Usually, the CAM creates drawing pattern data, which describes a drawing pattern where basic printed wiring patterns designed by the CAD are arranged in a substrate layout, and sequentially transfers the drawing pattern data to the RIP. The RIP converts the drawing pattern data into raster data (bitmap data) from which the exposure device can form an image, and sequentially transfers the raster data to the exposure device. The exposure device performs exposure in accordance with the raster data (bitmap data) supplied by the RIP, and thus forms an image such as a printed wiring pattern on the substrate.

As described above, it is common for the CAM to arrange the basic printed wiring patterns designed by the CAD in a substrate layout, as one drawing pattern and to create drawing pattern data which describes the drawing pattern. The RIP merely converts the drawing pattern data into bitmap data.

### DISCLOSURE OF THE INVENTION

### Problems to be Solved by the Invention

To draw many printed wiring patterns (hereinafter referred to as piece images) of very small size, as in the case of a cellular phone or the like, on a substrate, the following technology is being developed.

First, the CAM uses a format such as a Gerber format to create piece image data (hereinafter referred to as piece Gerber data) and layout information. The piece Gerber data describes a piece image where one or more circuit patterns that are designed by the CAD are arranged. The layout information is used in arranging piece images in a substrate layout. Next, the RIP converts the piece Gerber data created by the CAM into piece bitmap data, and creates drawing bitmap data (hereinafter referred to as substrate bitmap data) by arranging these many pieces of piece bitmap data in a substrate layout in accordance with the layout information.

Layout information used to arrange many piece images (piece bitmap data) in a substrate layout usually contains X·Y offset information, which indicates the relative positional relation in the X-axis direction and the Y-axis direction between the piece images on the substrate, and a STEP & REPEAT count, which indicates how many piece images are laid out on the substrate.

In manufacturing a multilayer printed wiring board, particularly in recent years in which printed wiring patterns or other images formed on a substrate are extremely minute, it is required to draw images with precision so that piece images drawn on different layers are aligned with each other.

However, in most cases, the substrate is warped by heat pressing or the like in the process of manufacturing a printed wiring board. As a result, to achieve such precise drawing in which piece images drawn on different layers are aligned with each other, even the use of layout information containing X·Y offset information and a STEP & REPEAT count as mentioned above in arranging piece images in a substrate layout may not be enough for compensating for a minuscule size variation among piece images and layout misalignment which are caused by the warping of the substrate.

As described above, to draw many piece images on a substrate, the RIP converts piece Gerber data created by the CAM into piece bitmap data, which is arranged in a substrate layout in accordance with layout information. Drawing a large number of piece images on a substrate means that there are many pieces of piece bitmap data to be arranged in a substrate layout by the RIP, which is very time-consuming and can lower the product's productivity.

The product's productivity may also be lowered in a case where magnification converting processing, rotation processing, or the like has to be performed on piece bitmap data prior to arrange the piece bitmap data in a substrate layout because many pieces of piece bitmap data go through the processing and it takes very long time.

A first object of this invention is to provide an image processing method, an image processor, a drawing system, and a program which solve the problems of prior art and which create substrate bitmap data by obtaining layout information and piece Gerber data, converting the piece Gerber data into piece bitmap data, and then arranging many pieces of the piece bitmap data in a substrate layout in accordance with the layout information, the layout information containing, at least, piece image position information, which describes where on the substrate each piece image is to be placed, and, if necessary, piece image magnification information, which indicates an image magnification at which each piece image is to be arranged in a substrate layout, and/or piece image rotation information, which is information on rotation applied to each piece image when arranged in a substrate layout, the piece Gerber data describing the piece images.

A second object of this invention is to provide an image processing method, an image processor, a drawing system, and a program which solve the problems of prior art and which create substrate drawing bitmap data by converting piece Gerber data into piece bitmap data, performing compression processing on the piece bitmap data, and then arranging the piece bitmap data in a substrate layout in accordance with layout information.

### Means for Solving the Problems

In order to attain the first object described above, according to a first aspect of the present invention, there is provided an image processing method of creating drawing data of an image in which plural piece images is arranged, comprising the steps of: obtaining image data which describes each piece image, and layout information of each piece image; converting said image data into piece drawing data which corresponds to said drawing data; and then arranging said piece drawing data based on said layout information to thereby create said drawing data of said image.

In order to attain the second object described above, according to another mode of the first aspect, it is preferable that the image processing method described above further comprises the step of: subjecting said piece drawing data to compression processing after said image data is converted into said piece drawing data, wherein said piece drawing data subjected to said compression processing is arranged based on said layout information to creating said drawing data of said image.

In other words, the present invention provides an image processing method of creating drawing data of an image in which plural piece images is arranged, comprising the steps of: obtaining image data which describes each piece image, and layout information of each piece image; converting said image data into piece drawing data which corresponds to said drawing data; subjecting said piece drawing data to compression processing; and then arranging said piece drawing data subjected to said compression processing based on said layout information to thereby create said drawing data of said image.

In order to attain the first object described above, according to a second aspect of the present invention, there is provided an image processor which creates drawing data of an image in which plural piece images is arranged, comprising: obtaining means for obtaining layout information of each piece image; storing means for receiving and storing image data which describes each piece image; converting means for converting said image data that has been stored in said storing means into piece drawing data which corresponds to said drawing data; and arranging means for arranging, based on said layout information, said piece drawing data that has been converted by said converting means to thereby create said drawing data of said image.

In order to attain the second object described above, according to another mode of the second aspect, it is preferable that the image processor described above further comprises: compression processing means for performing compression processing on said piece drawing data that has been converted by said converting means, wherein said arranging means arranges said piece drawing data on which said compression processing is performed by said compression processing means based on said layout information.

In other words, the present invention provides an image processor which creates drawing data of an image in which plural piece images is arranged, comprising: obtaining means for obtaining layout information of each piece image; storing means for receiving and storing image data which describes each piece image; converting means for converting said image data that has been stored in said storing means into piece drawing data which corresponds to said drawing data; compression processing means for performing compression processing on said piece drawing data that has been converted by said converting means; and arranging means for arranging, based on said layout information, said piece drawing data on which said compression processing is performed by said compression processing means to thereby create said drawing data of said image.

In the image processor according to the second aspect, said drawing data of said image may be created by obtaining said piece drawing data from an external device, performing compression processing on said piece drawing data, and then arranging said compressed piece drawing data in accordance with said layout information.

In order to attain the first and/or second object described above, according to a third aspect of the present invention, there is provided a drawing system comprising any one of the image processors according to the second aspect of the present invention and a drawing device, which performs drawing on a work based on drawing data that is created by the image processor.

In other words, the present invention provides a drawing system, comprising: an image processor which creates drawing data of an image in which plural piece images is arranged; and a drawing device which performs drawing on a work based on said drawing data that is created by said image processor, wherein said image processor comprises: obtaining means for obtaining layout information of each piece image; storing means for receiving and storing image data which describes each piece image; converting means for converting said image data that has been stored in said storing means into piece drawing data which corresponds to said drawing data; and arranging means for arranging, based on said layout information, said piece drawing data that has been converted by said converting means to thereby create said drawing data of said image.

In order to attain the first and/or second object described above, according to another mode of the third aspect, it is preferable that the drawing system described above further comprises: compression processing means for performing compression processing on said piece drawing data that has been converted by said converting means, wherein said arranging means arranges said piece drawing data on which said compression processing is performed by said compression processing means based on said layout information.

In order to attain the first object described above, according to a fourth aspect of the present invention, there is provided a computer-executable program for executing a image processing method of creating drawing data of an image in which plural piece images is arranged, comprising: a step of obtaining image data which describes each piece image, and layout information of each piece image; a step of converting said image data into piece drawing data which corresponds to said drawing data; and a step of arranging said piece drawing data based on said layout information to thereby create said drawing data of said image.

In order to attain the second object described above, according to another mode of the fourth aspect, it is preferable that the computer-executable program described above further comprises: a step of subjecting said piece drawing data to compression processing after said step of converting, wherein said arranging step arranges, based on said layout information, said piece drawing data which is subjected to said compression processing in said step of subjecting.

In any one of the above aspects of the present invention, it is preferable that said layout information contains, at least, information of each position on said image where each piece image is located.

In any one of the above aspects of the present invention, it is preferable that said layout information further contains at least one of magnification information and rotation information about each piece image.

According to any aspects of the present invention, piece images are arranged in a substrate layout in accordance with layout information containing, at least, piece image position information, which describes where on the substrate each piece image is to be placed, and, if necessary, piece image magnification information, which indicates an image magnification at which each piece image is to be arranged in a substrate layout, and/or piece image rotation information, which is information on rotation applied to each piece image when arranged in a substrate layout, so that minuscule size variation among piece images and layout misalignment are compensated in arranging the piece images in a substrate layout. Piece images can thus be arranged with high precision and a high degree of freedom.

According to any aspects of the present invention, substrate bitmap data in which the piece images (piece bitmap data) are arranged in a substrate layout in accordance with the layout information is further used to form an image on the substrate, thereby achieving such precise drawing that makes piece images drawn on different layers to be aligned with each other. The positional accuracy of wiring patterns can thus be kept high despite the recent trend of extreme miniaturization of printed wiring.

According to the other mode of any aspect of the present invention, piece bitmap data of small data size is arranged in a substrate layout by converting piece Gerber data into piece bitmap data, performing compression processing on the piece bitmap data, in other words, reducing the data size of the piece bitmap data through compression processing, and then arranging the piece bitmap data that has gone through the compression processing in a substrate layout in accordance with layout information. Thus, piece bitmap data can be arranged in a shorter period of time and a productivity improved from prior art is obtained.

According to the other mode of any aspect of the present invention, the productivity can be improved also in a case where magnification converting processing, rotation processing, or the like has to be performed on piece bitmap data prior to arranging the piece bitmap data in a substrate layout, since the processing is performed on compressed piece bitmap data that has been reduced in data size through compression processing and time spent for magnification converting processing, rotation processing, or the like on piece images is thus cut short.

### BRIEF DESCRIPTION OF DRAWINGS

FIG. 1 is a schematic block diagram showing an embodiment of an image recording system according to the present invention.

FIG. 2 is a schematic block diagram showing another embodiment of an image recording system according to the present invention.

### BEST MODE FOR CARRYING OUT THE INVENTION

A detailed description will be given below on an image processing method, image processor, drawing system, and program according to the present invention through preferred embodiments, which are shown in the accompanying drawings.

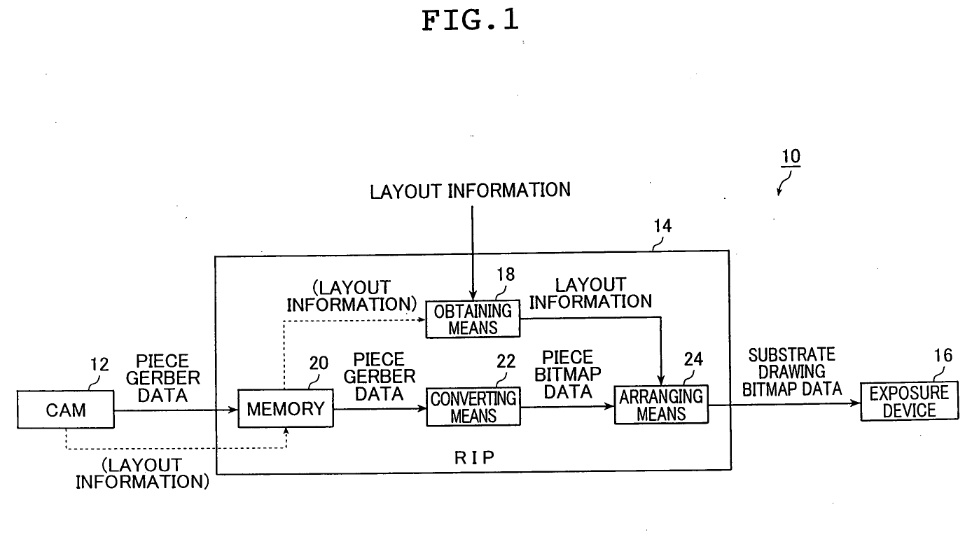

FIG. 1 is a schematic block diagram showing an embodiment of an image recording system which implements a drawing system with an image processor that carries out an image processing method according to the present invention.

An image recording system 10 is similar to the conventional image forming system described above in that it draws an image composed of plural piece images arranged on a substrate. However, the image recording system 10 receives layout information from an external device (not shown), obtains image data of the piece images, converts the image data into piece drawing data, and then creates substrate drawing data in which many pieces of piece drawing data are arranged in a substrate layout in accordance with the layout information, to thereby form an image on the substrate. The image recording system 10 has, as shown in FIG. 1, a CAM 12, an RIP 14, and an exposure device 16.

The CAM 12 and the RIP 14 are connected to each other via known communication means or a known network. The same applies to the RIP 14 and the exposure device 16.

The CAM (Computer Aided Manufacturing) 12 is a device that uses a format such as a Gerber format to create piece image data (hereinafter referred to as piece Gerber data), which describes a printed wiring pattern (hereinafter referred to as piece image) of very small size where one or more circuit patterns designed by CAD are arranged.

Basically, the image recording system 10 according to the present invention can employ, as the CAM 12, known CAM that is used in manufacture of a printed wiring board and the like.

The piece Gerber data is not limited to a particular format. The extended Gerber format (RS-274X) is given as a preferred example. The standard Gerber format (RS-274SD) is also employable. Other than the two, all of various data formats that normal CAM is capable of outputting can be employed.

Data to be processed by the CAM 12 is usually designed by and received from CAD. However, the present invention is not limited thereto, and the data may be received from other information sources.

The CAM 12 sequentially sends the piece Gerber data to the RIP 14. The data that has already been sent to the RIP 14 may be deleted from the CAM 12, if necessary.

The RIP (Raster Image Processor) 14 is an example of an image processor of the present invention which carries out an image processing method of the present invention. The RIP 14 is a device that converts the piece Gerber data obtained from the CAM 12 into bitmap data (hereinafter referred to as piece bitmap data) for image recording (exposure=printing on a substrate) in the exposure device 16, and lays out pieces of piece bitmap data on a substrate in accordance with externally obtained layout information (will be described later in detail) to create drawing bitmap data (hereinafter referred to as substrate drawing bitmap data). In the example shown in the drawing, the RIP 14 of this embodiment has obtaining means 18, a memory 20, converting means 22, and arranging means 24.

The obtaining means 18 obtains, from an external device (not shown), individual piece image layout information which is necessary in laying out pieces of piece bitmap data on a substrate.

The individual layout information, which is a feature of the present invention, contains, at least, piece image position information, which describes where on the substrate each piece image is to be placed, and, if necessary, piece image magnification information, which indicates an image magnification at which each piece image is to be arranged in a substrate layout, and/or piece image rotation information, which is information on rotation applied to each piece image when arranged in a substrate layout.

The present invention does not particularly limit how to obtain layout information. To give an example of employable methods, an operator uses a dedicated measuring device (not shown) to measure the area and through hole position of a substrate that is ready for exposure and to calculate from the measurement results and an area and a through hole position that have been measured in the last exposure, thereby obtaining position information, magnification information, and rotation information of each piece image, and stores the obtained layout information in the measuring device, from which the layout information is inputted to the obtaining means 18. In another example, an operator uses inputting means (not shown) such as a keyboard of the RIP 14 to input layout information obtained as described above in the measuring device.

Another method is employable in the case where the same image has been drawn before. In this case, position information, magnification information, and rotation information obtained at that time by calculation for each piece image are respectively averaged and stored in the RIP 14.

Other examples include a method in which how much a substrate is warped from heat pressing or the like is simulated in advance by the CAM 12 or others, or warp information previously databased is obtained, to calculate, for each piece image, position information, magnification information, and rotation information (layout information) that accommodate the warp. The layout information thus obtained through the simulation is transferred to the memory 20 along with piece Gerber data, so that the obtaining means 18 obtains the layout information from the memory 20.

From the methods given above as examples, one is chosen that suits a specific requirement in manufacture of a multilayer printed wiring board. For example, very high positional precision may be required, or a balance between positional precision and throughput may be considered. The methods given above as examples may be used in combination.

In the case where there is an intentional difference in where to draw a piece image between an upper layer and a lower layer in manufacture of a multilayer printed wiring board, the present invention allows the above layout information to have additional allocation information for performing desired processing.

In this embodiment, as an example, layout information used in the past to draw the same image is stored in the RIP 14 in advance.

The memory 20 stores piece Gerber data created by the CAM 12.

The memory 20 is not limited to a particular memory, and any known memory can be employed as long as it has enough storage capacity to store piece Gerber data.

The converting means 22 obtains piece Gerber data from the memory 20, and converts the piece Gerber data into piece bitmap data.

A known method can be used for processing of converting piece Gerber data into piece bitmap data. If necessary, the conversion of piece Gerber data into piece bitmap data may be followed by compression processing.

The arranging means 24 receives the piece bitmap data from the converting means 22 and the piece image layout information from the obtaining means 18, respectively, and creates substrate bitmap data in which the piece bitmap data is arranged in a substrate layout in accordance with the layout information.

The RIP 14 of this embodiment is basically structured as above. Through the following description on the operation of the RIP 14, the present invention, in particular, an image processing method of the present invention and a program of the present invention which carries out the image processing method will be described in more detail.

A program of the present invention causes the RIP 14 of this embodiment which is an image processor of the present invention to carry out the following operation, in other words, an image processing method.

In the RIP 14 of this embodiment, the memory 20 stores piece image Gerber data received by the RIP 14 from the CAM 12.

The converting means 22 reads piece Gerber data out of the memory 20, converts the read piece Gerber data into piece bitmap data, which corresponds to bitmap data, and supplies the piece bitmap data to the arranging means 24. The obtaining means 18 obtains layout information for piece bitmap data created by the converting means 22, and supplies the layout information to the arranging means 24. In this example, layout information is stored in the RIP 14 in advance as mentioned above. The arranging means 24 lays out the piece bitmap data supplied from the converting means 22 on a substrate in accordance with the layout information supplied from the obtaining means 18, thereby creating substrate bitmap data. The arranging means 24 sequentially supplies the substrate bitmap data to the exposure device 16.

In the case where layout information contains an image magnification of a piece image, the magnification of piece bitmap data is changed first by performing electronic magnification changing processing or the like on the piece bitmap data, and then the piece bitmap data is arranged in a substrate layout in accordance with the layout information.

In the case where layout information contains rotation information, piece bitmap data goes through rotation processing first, and then is arranged in a substrate layout in accordance with the layout information.

In the case where layout information contains an image magnification of a piece image and rotation information of the piece image, the magnification of piece bitmap data is changed first, then rotation processing is performed on the magnification-changed piece bitmap data, and lastly the piece bitmap data is arranged in a substrate layout in accordance with the layout information.

As described above, a conventional RIP creates substrate bitmap data in which piece images are arranged in a substrate layout in accordance with X·Y offset information of the piece images and STEP & REPEAT counts of the piece images, and uses the substrate bitmap data to draw an image on the substrate.

In most cases, however, the substrate may be warped by heat pressing or the like in the process of manufacture. With substrate bitmap data that uses the conventional method to lay out piece bitmap data on a substrate, it is difficult to compensate for a minuscule size variation among piece images and layout misalignment which are caused by the warping of the substrate, and it is difficult to achieve such a level of precise drawing that makes piece images drawn on different layers to be aligned with each other. As a result, the positional precision of wiring patterns is lowered, and particularly in recent years in which printed wiring is extremely minute, it is a serious problem leading to degradation of the printed wiring board.

In the present invention, substrate bitmap data is created by arranging piece images in a substrate layout in accordance with layout information containing, at least, piece image position information, which describes where on the substrate each piece image is to be placed, and, if necessary, piece image magnification information, which indicates an image magnification at which each piece image is to be arranged in a substrate layout, and/or piece image rotation information, which is information on rotation applied to each piece image when arranged in a substrate layout. Thus, a minuscule size variation among piece images and layout misalignment are compensated in laying out piece images on a substrate, and piece images can be arranged with high precision and a high degree of freedom.

In the present invention, the substrate bitmap data in which piece images (piece bitmap data) are arranged in a substrate layout in accordance with layout information is further used to form an image on the substrate, thereby achieving such precise drawing that makes piece images drawn on different layers to be aligned with each other. The positional accuracy of wiring patterns can thus be kept high despite the recent trend of extreme miniaturization of printed wiring, and quality deterioration of the printed wiring board is minimized.

The exposure device 16 is a device that forms an image on a substrate using substrate drawing bitmap data, which is sequentially supplied from the RIP 14.

Basically, the image recording system 10 according to the present invention can employ, as the exposure device 16, a known exposure device that is used in manufacture of a printed wiring board and the like.

As mentioned above, substrate drawing bitmap data used in exposure is sequentially supplied to the exposure device 16 from the RIP 14.

Meanwhile, a substrate on which an image is to be exposed is placed manually or automatically at a given position on a stage (not shown) of the exposure device 16.

Examples of a substrate on which an image is exposed by the exposure device 16 include a printed wiring board, a substrate on which a liquid crystal display device and other similar patterns are formed (through image exposure), and a glass plate or the like with photoresist such as photosensitive epoxy resin applied to its surface, or with a laminated dry film.

An instruction to start exposure is issued after a substrate is put on the stage, an operator designates an image to be formed, and a predicted position of an alignment mark formed on the substrate is designated. Receiving the instruction, the exposure device 16 first moves an alignment camera (not shown in the drawing) such as a CCD camera to the predicted position of the alignment mark. Next, the alignment camera takes a picture at the predicted position of the alignment mark to photograph the alignment mark.

An exposure point on the substrate is set, in other words, where on the substrate to draw a drawing pattern, is determined based on the position of the photographed alignment mark on the substrate and the predicted position of the alignment mark that has been designated as mentioned above. Thereafter, exposure of the substrate is started in accordance with the exposure position settings using substrate drawing bitmap data that corresponds to the designated image.

When the exposure of the image on the substrate is finished, the stage is driven to the downstream side in the exposure direction and returns to an original point, which is located on the most downstream side in the exposure direction (the most upstream side in the alignment measuring direction).

This completes the exposure operation performed by the exposure device 16 on a substrate.

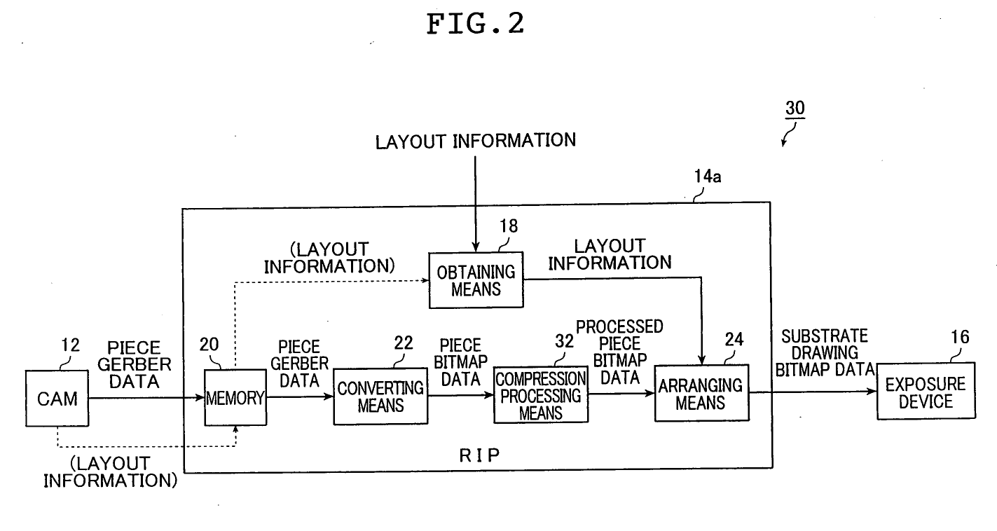

Next, another embodiment of an image recording system according to the present invention will be described with reference to FIG. 2.

FIG. 2 is a schematic block diagram showing another embodiment of an image recording system according to the present invention. An image recording system 30 shown in FIG. 2 has the same structure as the image recording system 10 shown in FIG. 1 except that an RIP 14a having compression means 32 is employed. Accordingly, common components are denoted by the same reference symbols, and will not be described in detail.

The image recording system 30 is a system that draws an image on a substrate in the same way as the image recording system 10 described above with reference to FIG. 1 except that the compression means 32 of the RIP 14a performs compression processing on piece bitmap data. The image recording system 30 is structured to have a CAM 12, the RIP 14a, and an exposure device 16 as shown in FIG. 2.

In this embodiment, too, the CAM 12 and the RIP 14a are connected to each other via known communication means or a known network. The same applies to the RIP 14a and the exposure device 16.

In this embodiment, too, the CAM 12 sequentially sends piece Gerber data to the RIP 14a. The data that has already been sent to the RIP 14a may be deleted from the CAM 12, if necessary.

The RIP 14a is similar to the RIP 14 shown in FIG. 1 in that it is an example of an image processor of the present invention which carries out an image processing method of the present invention. The RIP 14a is a device that converts piece Gerber data obtained from the CAM 12 into piece bitmap data for image recording in the exposure device 16, performs compression processing on the piece bitmap data, and then creates drawing bitmap data (substrate drawing bitmap data) having pieces of compressed piece bitmap data arranged in a substrate layout in accordance with externally obtained layout information. In the example shown in the drawing, the RIP 14a of this embodiment has obtaining means 18, a memory 20, converting means 22, compression processing means 32, and arranging means 24.

The RIP 14a of the image recording system 30 shown in FIG. 2 has the same structure as the RIP 14 of the image recording system 10 shown in FIG. 1 except for the compression means 32. Accordingly, common components are denoted by the same reference symbols to omit descriptions on those components and focus on differences between the two. What the RIP 14 of the image recording system 10 shown in FIG. 1 is capable of can be done with the RIP 14a of the image recording system 30 shown in FIG. 2.

In this embodiment, as in the embodiment shown in FIG. 1, layout information used in the past to draw the same image is stored in advance in the RIP 14a as an example.

The compression processing means 32 performs compression processing on piece bitmap data received from the converting means 22.

How to compress piece bitmap data is not particularly limited, and a known method can be employed. Run length compression (RL compression) is given as a preferred example.

The arranging means 24 receives the piece bitmap data that has gone through compression processing from the compression processing means 32 and the layout information of piece images from the obtaining means 18, respectively, and creates substrate bitmap data in which the compressed piece bitmap data is arranged in a substrate layout in accordance with the layout information.

The RIP 14a of this embodiment is basically structured as above. Through the following description on the operation of the RIP 14a, the present invention, in particular, an image processing method of the present invention and a program of the present invention which carries out the image processing method will be described in more detail.

A program of the present invention causes the RIP 14a of this embodiment which is an image processor of the present invention to carry out the following operation, in other words, an image processing method.

In the RIP 14a of this embodiment, the memory 20 stores piece image Gerber data received by the RIP 14a from the CAM 12.

The converting means 22 reads piece Gerber data out of the memory 20, converts the read piece Gerber data into piece bitmap data, which corresponds to bitmap data, and supplies the piece bitmap data to the compression processing means 32.

The compression processing means 32 performs compression processing on the piece bitmap data received from the converting means 22, and supplies the compressed bitmap data to the arranging means 24.

The obtaining means 18 obtains layout information for the compressed piece bitmap data that has been created by the compression processing means 32, and supplies the layout information to the arranging means 24. In this example, layout information is stored in the RIP 14a in advance as mentioned above.

The arranging means 24 receives the compressed piece bitmap data from the compression processing means 32, and the layout information from the obtaining means 18, respectively, thereby creating substrate bitmap data in which the compressed piece bitmap data is arranged in a substrate layout in accordance with the layout information. The arranging means 24 sequentially supplies the substrate bitmap data to the exposure device 16.

In the case where layout information contains magnification information and/or rotation information about each piece image, magnification changing processing and/or rotation processing is performed on piece bitmap data that has gone through compression processing, and then the piece bitmap data is arranged in a substrate layout in accordance with the layout information.

In this embodiment, compressed piece bitmap data is arranged in a substrate layout in accordance with layout information containing positional information and the like of each piece image. However, it is not limited thereto. Compressed piece bitmap data may be arranged in a substrate layout in accordance with conventional layout information containing an X·Y shift amount and a STEP & REPEAT count.

As described above, to draw many piece images on a substrate with prior art, an RIP converts piece Gerber data created by CAM into piece bitmap data, which is then arranged in a substrate layout in accordance with layout information. However, it is very time-consuming to arrange many pieces of piece bitmap data in a substrate layout, and the throughput in manufacture of such products as multilayer printed wiring boards can be lowered. Furthermore, in the case where layout information contains magnification information, rotation information, and the like about each piece image and given processing has to be performed on each piece image, prior art takes long in finishing the processing and it can affect the productivity.

In contrast, in this mode of the present invention, piece Gerber data is converted into piece bitmap data, compression processing is performed on the piece bitmap data, and the compressed piece bitmap data is arranged in a substrate layout in accordance with layout information. This makes the data size per piece bitmap data very small. Accordingly, time spent for arranging individual piece bitmap data in a substrate layout can be cut short and the productivity is improved compared to prior art.

The present invention improves the productivity also when given processing such as magnification changing processing or rotation processing has to be performed on piece bitmap data prior to arranging the piece bitmap data in a substrate layout, since the given processing is performed on the compressed bitmap data that has been reduced in data size through compression processing, and time spent for magnification processing, rotation processing, or the like can be thus cut short.

In the present invention, the compressed piece bitmap data is uncompressed by the RIP 14 or the exposure device 16 at a suitable point between creation of substrate drawing bitmap data and exposure (drawing). Substrate drawing bitmap data may be uncompressed in the RIP 14 after the substrate drawing bitmap data is created. Compressed substrate drawing bitmap data may be sent to the exposure device 16 to be uncompressed before exposure. Alternatively, the former two may be provided as options to choose from.

An image processing method, image processor, drawing system, and program according to the present invention have been described in detail through various embodiments. However, the present invention is not limited to the above embodiments, and various improvements and design modifications can be made without departing from the spirit of the present invention.

1. An image processing method of creating drawing data of an image in which plural piece images is arranged, comprising the steps of:
obtaining image data which describes each piece image, and layout information of each piece image;
converting said image data into piece drawing data; and
then arranging said piece drawing data based on said layout information to create said drawing data of said image.

2. The image processing method according to claim 1, further comprising the step of:
subjecting said piece drawing data to compression processing after said image data is converted into said piece drawing data,
wherein said piece drawing data subjected to said compression processing is arranged based on said layout information to creating said drawing data of said image.

3. The image processing method according to claim 1, wherein said layout information contains, at least, information of each position on said image where each piece image is located.

4. The image processing method according to claim 3, wherein said layout information further contains at least one of magnification information and rotation information about each piece image.

5. An image processor which creates drawing data of an image in which plural piece images is arranged, comprising:
obtaining means for obtaining layout information of each piece image;
storing means for receiving and storing image data which describes each piece image;
converting means for converting said image data into piece drawing data; and
arranging means for arranging, based on said layout information, said piece drawing data to create said drawing data of said image.

6. An image processor according to claim 5, further comprising:
compression processing means for performing compression processing on said piece drawing data that has been converted by said converting means,
wherein said arranging means arranges said piece drawing data on which said compression processing is performed by said compression processing means based on said layout information.

7. The image processor according to claim 5, wherein said layout information contains, at least, information of each position on said image where each piece image is located.

8. The image processor according to claim 7, wherein said layout information further contains at least one of magnification information and rotation information about each piece image.

9. A drawing system, comprising:
an image processor which creates drawing data of an image in which plural piece images is arranged, said image processor comprising:
obtaining means for obtaining layout information of each piece image;
storing means for receiving and storing image data which describes each piece image;
converting means for converting said image data into piece drawing data; and
arranging means for arranging, based on said layout information, said piece drawing data to create said drawing data of said image; and
a drawing device which performs drawing on a work based on said drawing data.

10. The drawing system according to claim 9, wherein said image processor further comprises:
compression processing means for performing compression processing on said piece drawing data that has been converted by said converting means,
wherein said arranging means arranges said piece drawing data on which said compression processing is performed by said compression processing means based on said layout information.

11. The drawing system according to claim 9, wherein said layout information contains, at least, information of each position on said image where each piece image is located.

12. The drawing system according to claim 11, wherein said layout information further contains at least one of magnification information and rotation information about each piece image.

13. A computer-executable program for executing a image processing method of creating drawing data of an image in which plural piece images is arranged, comprising:
a step of obtaining image data which describes each piece image, and layout information of each piece image;
a step of converting said image data into piece drawing data; and
a step of arranging said piece drawing data based on said layout information to create said drawing data of said image.

14. The computer-executable program according to claim 13, wherein said image processing method further comprises:
a step of subjecting said piece drawing data to compression processing after said step of converting,
wherein said arranging step arranges, based on said layout information, said piece drawing data which is subjected to said compression processing in said step of subjecting.

15. The computer-executable program according to claim 13, wherein said layout information contains, at least, information of each position on said image where each piece image is located.

16. The computer-executable program according to claim 15, wherein said layout information further contains at least one of magnification information and rotation information about each piece image.
